(19) United States
(12) Patent Application Publication
(10) Pub. No.: US 2013/0221851 A1
(43) Pub. Date: Aug. 29, 2013

(54) Sensorless LED Light Detection

(71) Applicant: Keven D. Coates, Cypress, TX (US)

(72) Inventor: Keven D. Coates, Cypress, TX (US)

(73) Assignee: TEXAS INSTRUMENTS INCORPORATED, Dallas, TX (US)

(21) Appl. No.: 13/406,827

(22) Filed: Feb. 28, 2012

(51) Int. Cl. H05B 37/02

(52) U.S. Cl. 315/130; 315/159

(57) ABSTRACT

A simple ambient light detection method that uses the same Light Emitting Diode both for illumination and for ambient light detection by alternatively forward and reverse biasing the Light Emitting Diode. The invention may be implemented without any additional hardware components when incorporated in a digital Light Emitting Diode driver circuit.

### TECHNICAL FIELD OF THE INVENTION

This invention relates to light sensing and illumination control.

### BACKGROUND OF THE INVENTION

Light emitting diodes, or LEDs, are one of the most common types of interface components. They are used in numeric displays, flashlights, liquid crystal display backlights, vehicle brake lights, traffic signals and power-on indicator lights among many other applications.

Because LEDs are so commonly used as light emitters it is easy to forget that they are fundamentally photodiodes, and as such are light detectors as well. Although they are not optimized for light detection, they may be used as such.

In most applications, it is desirable to turn the LED on or off and to modulate the light intensity depending on the ambient light. This is conventionally done by employing a separate photocell to measure ambient light intensity, and this photocell may be eliminated by using the illuminating LED to periodically measure the ambient light.

### SUMMARY OF THE INVENTION

A very low cost light detection and control method is shown that employs an LED to function both in the illumination mode, and also be operable to measure ambient light illuminating the LED. The function may be implemented with no additional hardware cost if incorporated in the LED driver circuit. Applications may include turning illumination on or off depending on ambient light, automatically adjusting LED display brightness, and monitoring a multi LED light for a defective LED, or to detect the gradual dimming of the LEDs as they approach the end of life point.

### BRIEF DESCRIPTION OF THE DRAWINGS

These and other aspects of this invention are illustrated in the drawings, in which:

FIG. 1 shows a basic circuit using an LED for illumination,

FIG. 2 illustrates an LED based light detection circuit,

FIG. 3 shows a comparator circuit used to derive a Pulse Width Modulated (PWM) signal to control the LED intensity,

FIG. 4 shows the resulting PWM wave forms, and

FIG. 5 shows a digital implementation of the sensor function.

### DETAILED DESCRIPTION OF PREFERRED EMBODIMENTS

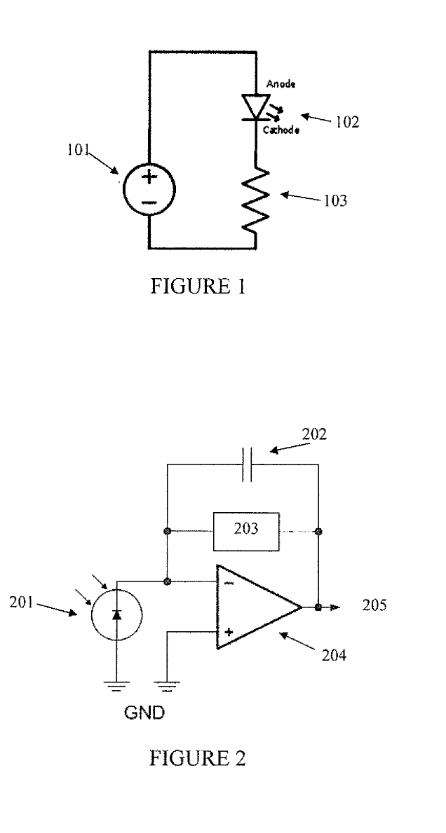

As shown in FIG. 1 (Prior Art) a basic circuit using an LED for illumination may be constructed by connecting a power source 101 to an LED 102, through a current limiting resistor 103. Resistor 103 may be used to control the light output of LED 102.

FIG. 2 (Prior Art) illustrates a simple circuit employing an LED for light sensing. LED 201 is connected to the inverting input of operational amplifier 204 in a backward biased configuration where the anode of the LED is connected to ground. Resistor 203 is connected from the output of the amplifier 204 to the inverting input of the amplifier, and is employed to set the gain of the comparator, while capacitor 202 in parallel with resistor 203 improves the stability of the circuit. Output 205 of the amplifier is a voltage representing the light intensity.

The emitted light intensity of an LED may be controlled by either varying a steady state current through the LED, or preferably by using a pulse modulated waveform (PWM). In this mode, the on time or duty cycle of the applied voltage is controlled to result in the desired average light intensity.

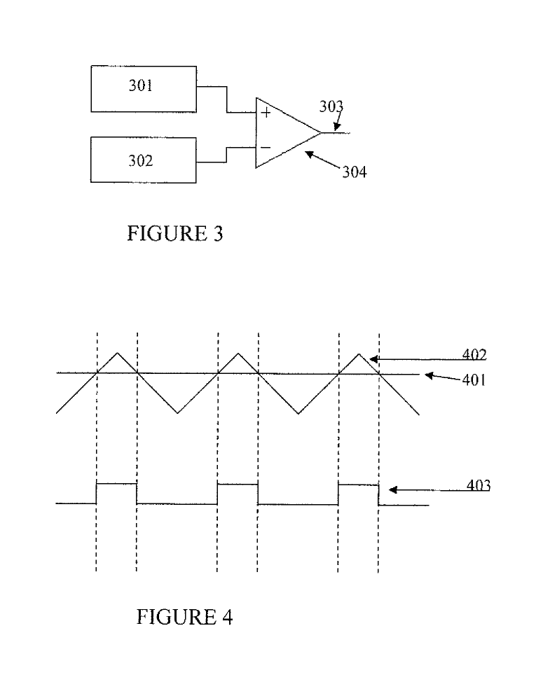

FIG. 3 (Prior Art) shows one possible method of generating a PWM waveform employing comparator 304. Triangle signal generator 301 is connected to the non-inverting input of the comparator, and a signal representing the measured light intensity, such as signal 205 from FIG. 2 is connected to the inverting input. Output 303 is the resulting PWM signal. FIG. 4 shows the resulting PWM signal 403, and the signal's relationship to the triangle shaped reference signal 402 with signal 401 being proportional to the light level desired.

While the above examples show discrete component implementations, the functions described can be easily implemented in the digital domain by a microcontroller. Since most LEDs are controlled by an integrated, digital LED driver circuit, the ambient light measurement function may also be integrated in the driver that would periodically switch the LED into measurement mode to detect the ambient light intensity.

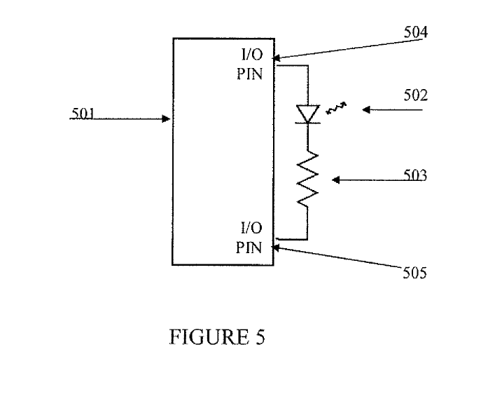

FIG. 5 illustrates a simple digital implementation of the sensor circuit using microcontroller 501. LED 502 and current limiting resistor 503 are serially connected between two programmable I/O pins. By setting the appropriate I/O pins high or low, the LED can be either forward biased and thus placed in the light emitting mode, or may be reverse biased to measure the ambient light intensity. In FIG. 5, I/O pin 505 is set high and I/O pin 505 is set low for light emitting mode. Light detection is a two step process. First I/O pin 505 is set low and I/O pin 505 is set high to reverse bias the Light Emitting Diode, and to charge the small capacitance formed by the circuit. Then I/O pin 505 is switched to a comparator input, and the time it takes to discharge the capacitance by the photocurrent is measured.

What is claimed is:

1. A method of light detection comprising the steps of:
reverse biasing a Light Emitting Diode, and
measuring the photocurrent generated by the Light Emitting Diode in response to the ambient illumination.

2. The method of claim 1 further comprising the steps of:
forward biasing the Light Emitting Diode to place it in the illuminating mode, and
periodically reverse biasing said Light Emitting Diode to detect ambient illumination.

3. The method of claim 2 wherein:
the light detection function is performed in the digital domain

4. The method of claim 1 wherein:
the presence or absence of detected ambient light will enable or disable the Light Emitting Diode being placed in the illuminating mode.

5. The method of claim 1 further comprising the steps of:
periodically measuring the light emitted from a plurality of Light Emitting Diodes,
storing the value representative of the light intensity,
comparing the latest intensity value to the previous value, and
indicating if the intensity has changed by more than a predetermined value.
